(19) United States
(12) Patent Application Publication
(10) Pub. No.: US 2005/0029764 A1
(43) Pub. Date: Feb. 10, 2005

(54) Barrow for moving observation

(75) Inventor: Takafumi Tanaka, Owariasahi City (JP)

Correspondence Address: OLIFF & BERRIDGE, PLC, P.O. BOX 19928, ALEXANDRIA, VA, 22320, US

(73) Assignee: National University Corporation Nagoya University, Nagoya City (JP)

(21) Appl. No.: 10/882,224

(22) Filed: Jul. 2, 2004

(30) Foreign Application Priority Data
Jul. 7, 2003 (JP) 2003-192,874

(51) Int. Cl. B62B 1/00

(52) U.S. Cl. 280/47.31

(57) ABSTRACT

This invention relates to a barrow for moving observation which observation equipment 5 is mounted and is driven by one wheel that contacts with a travel surface comprising an acceleration sensor 9 which detects the rotation angles around the mutually orthogonal x, y and z axes, a rotation angle sensor 10 which detects the rotation angles around the mutually orthogonal x, y and z axes, a wheel revolution sensor 8 which detects the revolution of the wheel, a computer 7 that calculate a position and a zenithal angle and a azimuthal angle of the direction of the observation of said equipment 5 in accordance with an information of self-contained navigation from said acceleration sensor 9 and said rotation angle sensor 10 and an information of moving distance from said wheel revolution sensor 8 at least in the observation by said equipment 5.

### BACKGROUND OF THE INVENTION

1. Field of the Invention

The present invention relates to a barrow for moving observation that is suitable for moving observation in the field such as a forest area, a construction field, an archaeological site and a disaster site where radio wave of global positioning system (GPS) is hard to reach.

2. Description of Related Art

Generally, when an observation of such as photoenvironment will carry out in the field such as the forest area, the construction field, the archaeological site and the disaster site where the radio wave of GPS is hard to reach, before the observation, preliminary works must be made, that is, select a relatively flat area and place the observation equipment on the observation area, identify the observation position by such as celestial observation and triangulation, and identify the zenithal angle and the azimuthal angle of the orientation for the observation of the equipment at the observation area.

However, as described above, setting the observation equipment and identifying the position and the orientation of the equipment as the preliminary works with respect to each observation are time-consuming and troublesome, so there is a problem that a quick and accurate moving observation is difficult to carry out.

### SUMMARY OF THE INVENTION

The object of this invention is to solve the above-mentioned problem advantageously. A barrow for moving observation of this invention which observation equipment is mounted and is driven by one wheel that contacts with the travel surface comprising a rotation angle sensor which detects the rotation angles around the mutually orthogonal three axes, a wheel revolution sensor which detects the revolution of the wheel, an observation position and direction calculating device that calculate a position and a zenithal angle and a azimuthal angle of the direction of the observation of said equipment in accordance with an information of self-contained navigation from said rotation angle sensor and an information of moving distance from said wheel revolution sensor at least in the observation by said equipment.

In the barrow for moving observation of this invention, the barrow with observation equipment is driven by hand gilding of an operator or power from a source of power such as motor which is equipped with this barrow and is traveled on a travel surface such as a trackless cant in a forest, a punishing road, a construction field, an archaeological site and a narrow aisle at a disaster site by one wheel is contact with the travel surface like a ground surface, road surface and a floor face. In the traveling of the barrow for observation, a rotation angle sensor detects the rotation angle of this barrow around the mutually orthogonal three axes which these axes are extended along such as the longitudinal direction, the transversal direction and the up-and-down direction of the barrow respectively, a wheel revolution sensor detects a revolution of the wheel, and the observation position and direction calculating device calculate a position of the equipment and a zenithal angle and an azimuthal angle of the direction of the observation of the equipment in accordance with an information of self-contained navigation from the rotation angle sensor and an information of moving distance from the wheel revolution sensor at least in the observation by said equipment which is mounted on the barrow, and output the position and the zenithal angle and the azimuthal angle of the direction of the observation of the equipment to a display device or a recording device.

Therefore, according to the barrow of this invention, there is no need for setting and identifying the position and the orientation of the equipment as a preliminary work with respect to each observation like the conventional observation, so that a quick and accurate moving observation can easily carry out in the field such as a forest area, a construction field, an archaeological site and a disaster site.

In the barrow of this invention, this barrow preferably comprises an acceleration sensor which detects the acceleration of the barrow that directed to the mutually orthogonal three axes and, the observation position and direction calculating device uses an information of self-contained navigation from the acceleration sensor to calculate the position and the zenithal angle and the azimuthal angle of the direction of the observation of the equipment. Thereby, the acceleration sensor detects the accelerations of the barrow in the directions of the mutually orthogonal three axes which these axes are extended along such as the longitudinal direction, the transversal direction and the up-and-down direction of the barrow respectively, and the observation position and direction calculating sensor also uses these accelerations to calculate the position the equipment and the zenithal angle and the azimuthal angle of the direction of the observation of the equipment, so that an error in the calculation of the position of the equipment will be able to reduce when an acceleration from any impact or the like occurs on the barrow.

Additionally, in the barrow of this invention, it is preferable that observation position and direction calculating device comprises a moving pathway calculation unit which continuously calculate the position of said equipment and calculate a moving pathway of the barrow in accordance with the transition of the position of the equipment and moving pathway display unit that indicates the calculated said moving pathway on a screen. Thereby, an observation operator in moving observation and a researcher who analyzes observation data in afterward can check the moving pathway of the barrow in the moving observation on the screen, so that the operator always can check the current position to prevent the risk of distress and the researcher will be able to carry out a detailed analysis of the data in reference to another data such as land features together.

Moreover, in the barrow of this invention, the barrow preferably comprises one or more auxiliary wheel that regulates the inclination over the predetermined limit of the barrow about said travel surface. Thereby, the inclination of the barrow about the longitudinal direction can parallelize that of the travel surface about the longitudinal direction of the barrow, so a workload of the operator can be reduced during the operator moves the barrow by hand gilding.

Furthermore, in the barrow of this invention, it is preferable that the observation equipment is at least one of the devices selected from three-dimensional scanner of the laser plane range-finding method, light wave distance meter, photoenvironment measurement device and digital still camera. Thereby, an observation such as a photoenvironment in the forest area can easily carry out.

Moreover, according to the measurement method of this invention, a quick and accurate moving observation can easily carry out in the field such as a forest area, a construction field, an archaeological site and a disaster site.

### BRIEF DESCRIPTION OF THE DRAWINGS

FIG. 1 is schematically perspective view of the appearance of the one embodiment of the barrow for moving observation of this invention.

FIG. 2 is a block diagram of the composition of the equipment that is mounted on the barrow of the embodiment of this invention.

### DETAILED DESCRIPTION OF THE PREFERRED EMBODIMENT

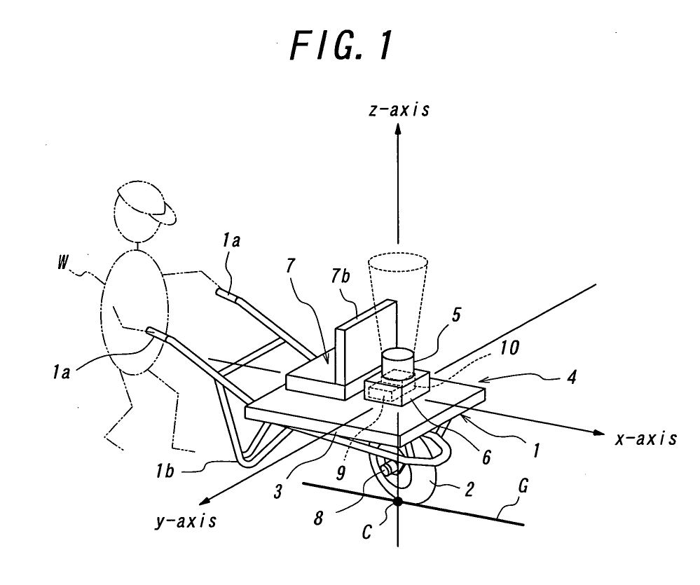

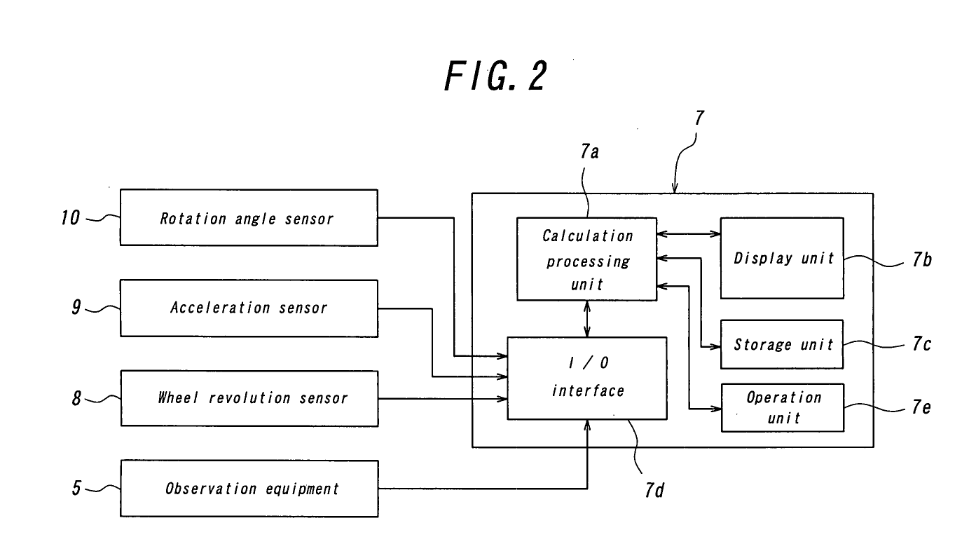

The embodiment according to this invention will be explained, by way of example, with reference to the accompanying drawings, in which FIG. 1 is schematically perspective view of the appearance of the one embodiment of the barrow for moving observation of this invention and FIG. 2 is a block diagram of the composition of the equipment that is mounted on the barrow of this embodiment.

As shown in FIG. 1, the barrow for moving observation of this embodiment comprises a dolly 4 which has a frame 1 with a handle for hand gilding and two stems for stay (there only shows one of the stems in the drawing), a wheel 2 which is rotatably supported around the axis at the underneath of frame 1 and a top plate 3 which is mounted on the frame 1, this dolly 4 is driven by hand gilding drive of a observation operator W and by means of the wheel 2 which contact on the grounding point C of the ground level G as the driving surface. The dolly 4 further comprises an observation equipment 5, an angle and acceleration sensor unit 6, a commercially available laptop computer 7, and a portable power supply (not shown), each of which are mounted to the top plate 3, and a wheel revolution sensor 8 which is mounted frame 1 and detects the revolution of the wheel 2. The angle and acceleration sensor unit 6 contains an acceleration sensor 9 which detects the acceleration of the dolly 4 in the directions of mutually orthogonal three axes, that is, x-axis, y-axis and z-axis respectively, and a rotation angle sensor 10 which detects the rotation angle of the dolly 4 around the mutually orthogonal three axes, that is, x-axis, y-axis and z-axis respectively.

The dolly 4 is made from a commercially available two-wheel barrow (for example, CC3-2FA made by Showa Bridge Sales Co., Ltd.) by removing its original two wheels which are line up on the axis which is extended to the transversal direction, instead one wheel 2 is mounted the intermediate position between where the original two wheels were mounted, and removing its original plastic body, alternatively the flat top plate 3 of plywood is mounted on the frame 1. The wheel revolution sensor 8 is consisted from two potentiometers (for example, CPP-45RBN 22.7k Ω made by NIDEC COPAL ELECTRONICS Corp.) which are placed on the axle of the wheel 2 serially. Since this potentiometer has a dead angle that cannot detect its angle, so these potentiometers are positioned to locate its each dead angle are staggered at 180° each other to prevent these potentiometers are in dead angle at the same time.

The angle and acceleration sensor unit 6 is consisted from commercially available products (for example, three axes angle sensor GU-3024 made by Datatec Co., Ltd.), as shown in FIG. 1, the acceleration sensor 9 is positioned to make its x-axis is extended to parallel with the x-axis of specific coordinate system of the barrow 1 which is extended along the longitudinal direction of the barrow 1 and is parallel to the surface of the top plate 3, and its y-axis is extended to parallel with the y-axis of specific coordinate system of the barrow 1 which is extended along the transversal direction of the barrow 1 and is parallel to the surface of the top plate 3, and its z-axis is extended to parallel with the z-axis of specific coordinate system of the barrow 1 which is extended along the up-and-down direction of the barrow 1 and is orthogonal to the surface of the top plate 3, and the rotation angle sensor 10 which is consisted by a gyro that is housed in the sensor is positioned to make its x-axis is extended along the longitudinal direction of the barrow 1 to be identical with the x-axis of specific coordinate system of the barrow 1, and its y-axis is extended along the transversal direction of the barrow 1 to be identical with the y-axis of specific coordinate system of the barrow 1, and its z-axis is extended to be orthogonal with the axle of the wheel 2 at the center of the wheel and to be identical with the z-axis of specific coordinate system of the barrow 1 at the up-and-down direction of the barrow 1. The portable power supply which is not shown in the drawings is a built-in battery inverter (for example, a portable power supply Z-130 made by SWALLOW ELECTRIC Co., Ltd.) which out put AC100V power to the angle and acceleration sensor 6 and the personal computer 7 as a power supply.

Additionally, in this embodiment, the data of three-dimensional acceleration and the data of three-dimensional angle that are respectively detected by the acceleration sensor 9 and the rotation angle sensor 10 in the angle and acceleration sensor 6 are input to the laptop computer 7 through RS232C cable. Each terminal for power source of two potentiometers which consists the wheel revolution sensor 8 are connected together in parallel to make a parallel circuit, and fixed resistor of 20k Ω is connected the circuit in serial. A power of about 6V by four size D batteries that are connected in serial is impressed to whole of the circuit and the resistor, the three voltage value, that is,.the voltage of both ends of the parallel circuit (V0) which is consisted by two potentiometers and each voltage of the terminals (variable resistance intermediate terminal) of both of each potentiometers (V1, V2) are input independently to the laptop computer 7 via A/D converter circuit card (for example, REX-5054U made by RATOC Systems Inc.) which is inserted in the card slot of the laptop computer 7.

Moreover, in this embodiment, the data from the observation equipment 5 that is mounted to the top plate 3 are input to the laptop computer 7 via another interface card that is inserted in the other card slot of the computer 7. As the observation equipment, for example, three-dimensional scanner of the laser plane range-finding method, light wave distance meter, photoenvironment measurement device and digital still camera may be equipped on the barrow, if the three-dimensional scanner or the digital still camera is equipped, by using the IEEE1394 interface card (for example, REX-CBFW1-L made by RATOC Systems Inc.) and insert this card to the card slot, or if the light wave distance meter or photoenvironment measurement device is equipped, by using RS232C interface card (for example, REX-5056V made by RATOC Systems Inc.) and insert this card to the card slot, capturing of the observation data into the computer 7 will be able to carry out.

Furthermore, as shown in FIG. 2, the laptop computer 7 comprises a calculation processing unit 7a having a central processing unit (CPU), a display unit 7b with a liquid crystal display, a storage unit 7c with some storage device such as a memory and a hard disk drive, I/O interface 7d with the above-mentioned interface card in the card slot, and an operation unit with some operation device such as keyboard. Thereby, the computer 7 processes the observation data from the above-mentioned observation equipment in accordance with a program which is previously stored in the memory as described later, then output the result of the data processing on the screen of the display unit 7b together with the observation data from the observation equipment 5 and stores the data in the storage unit 7c. In addition, the output voltage V1, V2 of the two potentiometers of the wheel revolution sensor 8 are converted to the rotation angle of the wheel 2 to select the output value from V1/V0 or V2/V0 which is not a value of its dead angle.

In the moving observation by using the barrow of this embodiment, at first, the laptop computer 7 is turn on and the program activate, and the angle and acceleration sensor unit 6 is turn on and the acceleration sensor 9 and the rotation angle sensor 10 activate. The computer 7 executes the program and utilizes the position of x-axis, y-axis and z-axis of the sensor unit 6 at the activation as a fundamental coordinate system in the data processing.

Subsequently, as the observation operator W drives the barrow by hand gilding, the computer 7 calculate the moving distance of the dolly 4, that is, of the barrow in real time from the rotation angle of the wheel 2 which is converted from the output data of the potentiometer of the wheel revolution sensor 8 and the outer diameter of the wheel 2, after that the computer 7 calculates the current position of the barrow, then, the observation equipment 5 by decomposing the moving distance to the each components in the directions of x-axis, y-axis and z-axis of the fundamental coordinate system with the use of the three-dimensional direction angle of the posture of the dolly 4, that is, the barrow from the output data from the rotation angle sensor 10, moreover, the computer 7 calculates the present position and the zenithal angle and the azimuthal angle of the direction for the observation of the equipment 5 by using the three-dimensional angle of the posture of the barrow which are obtained from the output data from the rotation angle sensor 10, then, the computer 7 stores these calculated data in the hard disk drive of the storage unit 7c. Furthermore, when the operator activates the observation equipment 5 during drive the barrow or stop the barrow accordingly, the computer 7 processes the output data of the equipment 5 and makes the data in the form of the predetermined data as the results of the observation, then stores these results in the hard disk drive of the storage unit 7c associate with the present position and the present orientation of the observation of the equipment 5.

Since it can not be expected that the operator will be able to drive the barrow by hand gilding with keeping up the top plate 3 with parallel to the inclination of the ground level G of the longitudinal direction of the dolly 4, it is necessary to be previously checked the tilt value of the top plate 3 on the ground level G of the flat land when the operator holds the handle la of the dolly 4 with respect to different plural operators and input each of the tilt value to the computer 7. Thereby, the computer 7 will compensate the rotation angle of the barrow that is output from the rotation angle sensor 10 to the amount of the each tilt value.

Moreover, if the revolution status of the wheel 2 which based on the output data from the wheel revolution sensor 8 does not correspond to the generation status of the acceleration which based on the output data of the acceleration sensor 9 (for example, in the case that an acceleration for longitudinal direction is detected although the wheel is not revolving), it is presumed that the acceleration of the dolly 4 is generated by impact or the like and the wheel 2 does not revolve corresponding to the amount of the actual moving distance, so that the computer 7 will perform integration of the acceleration that is detected by the acceleration sensor 9 in two times to obtain the moving distance of the wheel 2 at the direction of the acceleration, and compensate the moving distance that is previously calculated from the rotation angle of the wheel 2 according to the distance which is calculated from the detected acceleration.

Furthermore, the computer 7 calculate the moving trajectory of the barrow from the transition of the present position of the observation equipment 5 as the moving pathway calculation means, and display the moving trajectory in a map or a plan view on the liquid crystal display of the display unit 7b as the moving pathway display means, in addition, the result of the observation of the equipment 5 is displayed on the liquid crystal display of the display unit 7b with the above-described moving trajectory or by switching the display image.

Therefore, according to the barrow of this embodiment, there is no need for setting and identifying the position and the orientation of the equipment as a preliminary work with respect to each observation like the conventional observation, so that a quick and accurate moving observation is can easily carry out in the field such as a forest area, a construction field, an archaeological site and a disaster site.

Additionally, according to the barrow of this embodiment, the computer 7 continuously calculate the position of the equipment 5 and calculate a moving pathway of the barrow in accordance with the transition of the position of the equipment 5 and display the pathway of the barrow, so that an observation operator in moving observation and a researcher who analyzes observation data in afterward can check the moving pathway of the barrow in the moving observation on the screen, so that the operator always can check the current position to prevent the risk of distress and the researcher will be able to carry out a detailed analysis of the data in reference to another data such as land features together.

Moreover, according to the barrow of this embodiment, the barrow can equip the three-dimensional scanner of the laser plane range-finding method, light wave distance meter, photoenvironment measurement device and digital still camera as the observation equipment 5, so that, the observation such as a photoenvironment in the forest area will be able to easily carry out.

This invention is explained above in accordance with the embodiment. However, this invention is not limited by the embodiment. For example, the barrow of this embodiment may also comprise one or more auxiliary wheel that regulates the inclination of the barrow over the predetermined limit about the travel surface. Thereby, the inclination of the barrow about the longitudinal direction can correspond to that of the travel surface, so a workload of the operator can be reduced during the operator moves the barrow by hand gilding.

Additionally, when the barrow of this invention is used on the relatively flat and nonskid travel surface such as pavement, the acceleration sensor which detects the acceleration of the barrow in the directions of mutually orthogonal three axes may be omitted. Moreover, the barrow of this invention may be mounted the source of the power such as motor to aid the hand gilding by the operator or moving itself as the operator holds the handle. Furthermore, the barrow of this invention is not of hand gilding, but also driving by an animal such as horse or donkey by holding the member of the barrow like handle with the use of habiliment.

Consequently, according to the barrow of this invention, there is no need for setting and identifying the position and the orientation of the equipment as a preliminary work with respect to each observation like the conventional observation, so that a quick and accurate moving observation is can easily carry out in the field such as a forest area, a construction field, an archaeological site and a disaster site.

1. A barrow for moving observation which observation equipment is mounted and is driven by one wheel that contacts with a travel surface comprising:
A rotation angle sensor that detects the rotation angles around the mutually orthogonal three axes,
A wheel revolution sensor that detects the revolution of the wheel,
An observation position and direction calculating device that calculate a position and a zenithal angle and a azimuthal angle of the direction of the observation of said equipment in accordance with an information of self-contained navigation from said rotation angle sensor and an information of moving distance from said wheel revolution sensor at least in the observation by said equipment.

2. A barrow according to claim 1, further comprising an acceleration sensor which detects the acceleration of the barrow that directed to the mutually orthogonal three axes and,
Said observation position and direction calculating device uses information of self-contained navigation from said acceleration sensor to calculate the position and the zenithal angle and the azimuthal angle of the direction of the observation of said equipment.

3. A barrow according to claim 1, wherein,
Said observation position and direction calculating device comprises:
A moving pathway calculation unit which continuously calculate the position of said equipment and calculate a moving pathway of the barrow in accordance with the transition of the position of the equipment and,
A moving pathway display unit that indicates the calculated said moving pathway on a screen.

4. A barrow according to claim 1, further comprising one or more auxiliary wheel that regulates the inclination of the barrow over the predetermined limit about said travel surface.

5. A barrow according to claim 1, wherein,
Said equipment is at least one of the devices selected from three-dimensional scanner of the laser plane range-finding method, light wave distance meter, photoenvironment measurement device and digital still camera.

6. A measurement method using the barrow according to claim 1.

7. A barrow according to claim 2, wherein,
Said observation position and direction calculating device comprises:
A moving pathway calculation unit which continuously calculate the position of said equipment and calculate a moving pathway of the barrow in accordance with the transition of the position of the equipment and,
A moving pathway display unit that indicates the calculated said moving pathway on a screen.

8. A barrow according to claim 2, further comprising one or more auxiliary wheel that regulates the inclination of the barrow over the predetermined limit about said travel surface.

9. A barrow according to claim 3, further comprising one or more auxiliary wheel that regulates the inclination of the barrow over the predetermined limit about said travel surface.

10. A barrow according to claim 2, wherein,
Said equipment is at least one of the devices selected from three-dimensional scanner of the laser plane range-finding method, light wave distance meter, photoenvironment measurement device and digital still camera.

11. A barrow according to claim 3, wherein,
Said equipment is at least one of the devices selected from three-dimensional scanner of the laser plane range-finding method, light wave distance meter, photoenvironment measurement device and digital still camera.

12. A barrow according to claim 4, wherein,
Said equipment is at least one of the devices selected from three-dimensional scanner of the laser plane range-finding method, light wave distance meter, photoenvironment measurement device and digital still camera.

13. A measurement method using the barrow according to claim 2.

14. A measurement method using the barrow according to claim 3.

15. A measurement method using the barrow according to claim 4.

16. A measurement method using the barrow according to claim 5.
